(19) United States
(12) Patent Application Publication
(10) Pub. No.: US 2019/0012039 A1
(43) Pub. Date: Jan. 10, 2019

(54) OPERATION DETECTION DEVICE

(71) Applicant: KABUSHIKI KAISHA TOKAI RIKA DENKI SEISAKUSHO, Aichi (JP)

(72) Inventor: Hiroshi MISAWA, Aichi (JP)

(21) Appl. No.: 16/066,433

(22) PCT Filed: Jan. 19, 2017
(86) PCT No.: PCT/JP2017/001737

§ 371 Date: Jun. 27, 2018

(30) Foreign Application Priority Data
Jan. 28, 2016 (JP) 2016-014165

(51) Int. Cl. G06F 3/041

(52) U.S. Cl. CPC G06F 3/0418

(57) ABSTRACT

An operation detection device includes an operation detection unit configured to periodically detect an operation performed on an operating surface by a detection target and to calculate a detection point on the operating surface, the detection point being a point where the detection target is detected, a history information generation unit configured to store the detection point as a time series to generate a history information, and a controller configured to perform a calibration of the operation detection unit if the controller determines, based on the history information of the operation detected by the operation detection unit, that the operation detected is not a continuous operation.

### TECHNICAL FIELD

The present invention relates to an operation detection device.

### BACKGROUND ART

A known electronic device includes a touch sensor and a controller configured to perform calibration in the case that, per unit time, a reaction area is equal to or greater than a predetermined first area, the reaction area corresponding to a signal greater than a threshold value. The signal is output from the touch sensor. In the calibration, adjustment is made by offsetting the signal output from the touch sensor (see Patent Document 1, for example).

The electronic device disclosed in Patent Document 1 performs calibration by determining whether an erroneous reaction is due to low temperature, based on the state of changes in signals on the touch sensor after resuming, at which the display on the screen is resumed from the suspend state, in which the display on the screen is deactivated.

### CITATION LIST

### Patent Document

### Patent Document 1: JP 2014-119931A

### SUMMARY OF INVENTION

### Technical Problem

The electronic device disclosed in Patent Document 1 makes a determination as to an erroneous reaction after resuming, and thus, in some cases, it takes time to complete calibration after the occurrence of an erroneous reaction. Thus, the operability is not good.

An object of an aspect of the invention is to provide an operation detection device configured to perform calibration upon the occurrence of an anomaly in detection of operations and thus having improved operability.

### Solution to Problem

According to an embodiment of the invention, an operation detection device includes an operation detection unit, a history information generation unit, and a controller. The operation detection unit is configured to periodically detect an operation performed on an operating surface by a detection target and to calculate a detection point on the operating surface. The detection point is a point where the detection target is detected. The history information generation unit is configured to store the detection point as a time series to generate history information. The controller is configured to perform calibration of the operation detection unit in a case that the controller determines, based on the history information, regarding operations detected by the operation detection unit, that the operation detected is not a continuous operation.

### Advantageous Effects of Invention

Embodiments of the invention provide operation detection devices configured to perform calibration upon the occurrence of an anomaly in detection of operations and thus having improved operability.

### BRIEF DESCRIPTION OF DRAWINGS

FIG. 1A is a schematic diagram illustrating an example in which an operation detection device according to an embodiment is installed in the interior of a vehicle.

FIG. 1B is a block diagram illustrating a configuration of the operation detection device.

FIG. 2A is a schematic diagram illustrating a two-dimensional coordinate system defined on the touch pad of the operation detection device according to the embodiment.

FIG. 2B is a schematic diagram illustrating an example of a shift of a detection point on the two-dimensional coordinate system.

FIG. 3A is a schematic diagram illustrating an example of a shift of a detection point detected by the operation detection device according to the embodiment.

FIG. 3B is a schematic diagram illustrating an example of a shift of a detection point detected by the operation detection device according to the embodiment.

FIG. 3C is a schematic diagram illustrating an example of a shift of a detection point detected by the operation detection device according to the embodiment.

FIG. 4 is a flowchart illustrating processing performed by the operation detection device according to the embodiment.

### DESCRIPTION OF EMBODIMENT

### Overview of Embodiment

An operation detection device according to an embodiment includes an operation detection unit, a history information generation unit, and a controller. The operation detection unit is configured to periodically detect an operation performed on the operating surface by a detection target and to calculate the detection point on the operating surface. The detection point is a point where the detection target is detected. The history information generation unit is configured to store the detection point as a time series to generate history information. The controller is configured to perform calibration of the operation detection unit in a case that the controller determines, based on the history information, regarding operations detected by the operation detection unit, that the operation detected is not a continuous operation.

The operation detection device is configured to determine, based on the history information, that operation continuity is absent, with the detection point shifting randomly, in other words, that there is an anomaly in detection of operations, which may be due to, for example, a decrease in the temperature of the operating surface during operation by the operator. Thus, the operation detection device can rapidly perform calibration. Consequently, the operation detection device can carry out calibration in a short time compared with the case in which calibration is performed at a predetermined timing, and thus the operability is improved.

### Embodiment

### Overview of Operation Detection Device 1

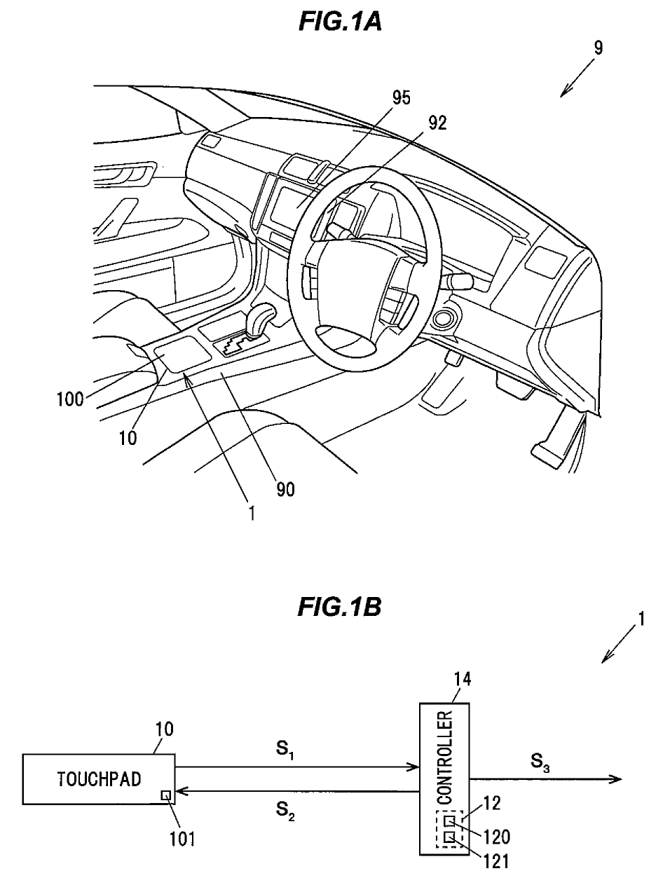

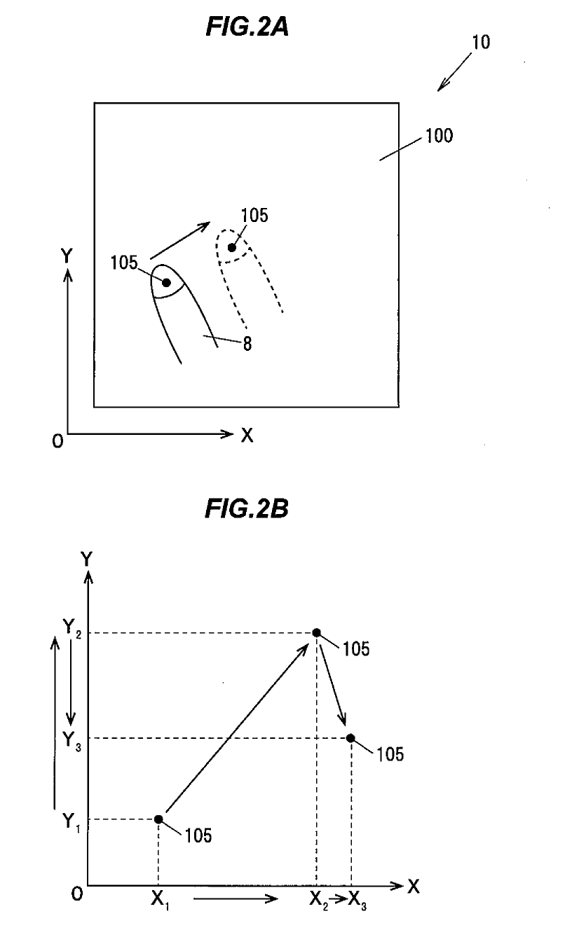

FIG. 1A is a schematic diagram illustrating an example in which the operation detection device according to the embodiment is installed in the interior of a vehicle. FIG. 1B is a block diagram illustrating a configuration of the operation detection device. FIG. 2A is a schematic diagram illustrating a two-dimensional coordinate system defined on the touch pad of the operation detection device according to the embodiment. FIG. 2B is a schematic diagram illustrating an example of a shift of a detection point on the two-dimensional coordinate system. In the drawings associated with the following embodiment, ratios between elements in the drawings may be different from the actual ratios. In addition, in FIG. 1B, arrows indicate the flows of primary signals, information, and the like.

As illustrated in FIG. 1A, the operation detection device 1 is installed, for example, in a floor console 90 between a driver's seat and a passenger's seat of a vehicle 9. The operation detection device 1 is electromagnetically connected, for example, to electronic devices mounted in the vehicle 9. Examples of such electronic devices include automotive navigation devices, audio playback devices, air conditioning devices, and the like.

The operation detection device 1 is configured to, for example, operate a cursor displayed on a display device 95, which is installed in a center console 92. The display device 95 functions as a display for electronic devices, such as those described above.

As illustrated in FIGS. 1B, 2A, and 2B, the operation detection device 1 includes a touch pad 10, which serves as the operation detection unit, a memory 12, which serves as the history information generation unit, and a controller 14, which serves as the controller. The touch pad 10 periodically detects an operation performed on an operating surface 100 by a detection target and calculates a detection point 105 on the operating surface 100. The detection point 105 is a point where the detection target is detected. The memory 12 stores the detection point 105 as a time series to generate history information 120. The controller 14 performs calibration of the touch pad 10 in the case that the controller 14 determines, based on the history information 120, regarding operations detected by the touch pad 10, that the operation detected is not a continuous operation.

In the following, the detection target is an operating finger 8 of the operator. The touch pad 10 is capable of detecting the operating finger 8 when the operating finger 8 approaches the operating surface 100, by using a touch threshold 101, which is preset. Thus, detection of the operating finger 8 includes detection through contact of the operating finger 8 with the operating surface 100 and detection through approach of the operating finger 8 to the operating surface 100.

### Configuration of Touch Pad 10

The touch pad 10 is an electrostatic capacitance-type touch sensor that detects a touched position (detection point 105) on the operating surface 100 when the operating surface 100 is touched by a part of the operator's body (operating finger 8, for example) or with a conductive pen, for example. The operator can operate a connected electronic device by, for example, performing a tracing operation on the operating surface 100.

As illustrated in FIG. 2A, the touch pad 10 includes, for example, a two-dimensional coordinate system (XY coordinate system) defined on the operating surface 100. The two-dimensional coordinate system includes a first coordinate axis (X coordinate axis) and a second coordinate axis (Y coordinate axis) intersecting the first coordinate axis. As illustrated in FIG. 2A, the two-dimensional coordinate system is an orthogonal coordinate system, with the origin being at a lower left position when viewed from the operator, seated in the driver's seat. Instead, the origin may be at an upper left position, for example.

The touch pad 10 includes, for example, driving electrodes and read electrodes. The driving electrodes may be spaced at regular intervals along one of the coordinate axes and may be supplied with an electrical current sequentially. The read electrodes may be spaced at regular intervals along the other of the coordinate axes and may be used to sequentially read electrostatic capacitances formed with the driving electrodes. As illustrated in FIG. 2A, the electrostatic capacitance changes when the operating surface 100 is approached or touched by the operating finger 8. The touch pad 10 is, for example, configured to convert read analog electrostatic capacitance values into digital values.

The touch pad 10 performs a function of reading the electrostatic capacitance by using each of the combinations of the driving electrodes and the read electrodes, that is, performs scanning for one period, to calculate a detection point 105, which is a point of detection of the operating finger. The touch pad 10 includes, for example, a touch threshold 101 and calculates, based on an electrostatic capacitance having a value equal to or greater than the touch threshold 101, the coordinates of the detection point 105. Calculation of the coordinates may be carried out by weighted averaging, for example.

For example, it is desirable that the electrostatic capacitances read from the touch pad 10 be of the same value (zero, for example) in a reference state in which the operating surface 100 is neither approached nor contacted by the operating finger. The touch pad 10, however, may have different electrostatic capacitances in the reference state when affected by noise or temperature, for example.

Accordingly, the touch pad 10, for example, performs calibration by offsetting the electrostatic capacitances so that the electrostatic capacitance in the reference state can be of a reference value (zero, for example), that is, by initializing the electrostatic capacitances. With this calibration, the touch pad 10, by using post-calibration electrostatic capacitances as reference values, compares the difference between the reference value and a read electrostatic capacitance with the touch threshold 101 to determine the presence or absence of an operation.

The touch pad 10, for example, performs the first calibration upon powering of the vehicle 9. Subsequently, as illustrated in FIG. 1B, the touch pad 10 performs calibration based on a calibration signal S₂, which is output from the controller 14. The calibration signal S₂ will be described later.

The touch pad 10 generates detection point information S₁, which includes information regarding a detection point 105, for each of the periods, and outputs the detection point information S₁ to the controller 14. The period for scanning may be 10 ms, for example.

### Configurations of Memory 12 and Controller 14

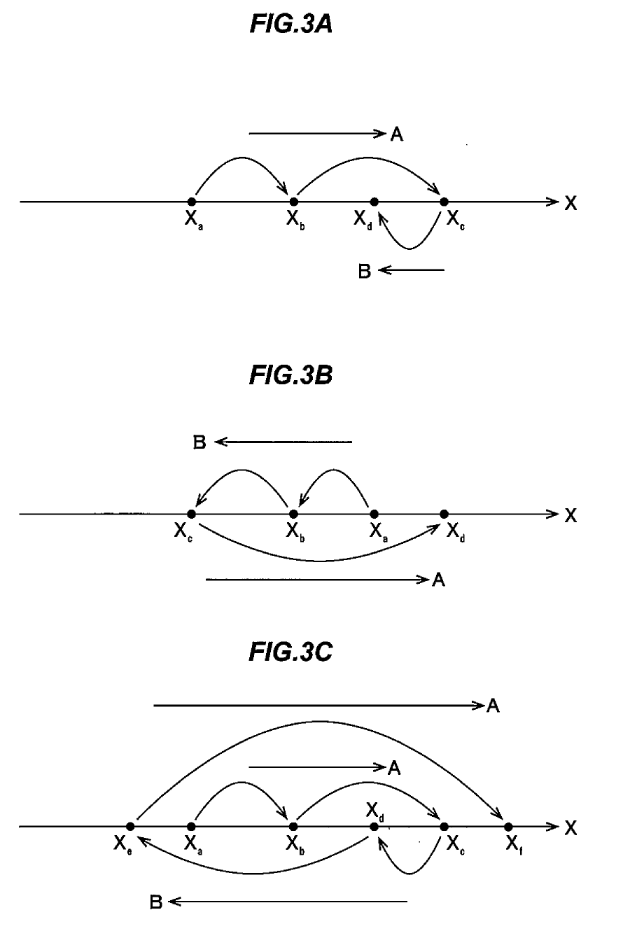

FIGS. 3A to 3C are schematic diagrams each illustrating an example of a shift of a detection point detected by the operation detection device according to the embodiment.

FIGS. 3A to 3C are intended to describe examples of how a determination as to operation continuity is made and only illustrate X components.

The controller 14 is, for example, a microcomputer including a central processing unit (CPU) that carries out computations, processes, and the like on acquired data in accordance with a stored program, a random access memory (RAM) and a read only memory (ROM) that are semiconductor memories, and the like. A program for operations of the controller 14, for example, is stored in the ROM. The RAM is used as a storage region that temporarily stores computation results and the like, for example.

The memory 12 according to the present embodiment is, for example, a RAM, as described above. A modified example of the memory 12 may be a storage unit electrically connected to the controller 14.

The controller 14 periodically acquires detection point information S₁ from the touch pad 10 and outputs, based on the acquired detection point information S₁, at least information regarding the coordinates of the detection point 105 to the memory 12 to store the information, as history information 120, in the memory 12.

For example, the history information 120 at least includes information regarding the coordinates of detection points 105 previously detected for two periods. The history information 120 is updated from information regarding the oldest detection point 105.

In the case that, based on the history information 120, it is detected that a shift of the detection point 105 is in one direction, and subsequently it is detected that the detection point 105 is in a reverse direction, the controller 14 compares a reverse detection point, which is the detection point in the reverse direction, with a previous detection point, which is a detection point a plurality of periods earlier than the reverse detection point, and, in the case that the controller 14 finds that the reverse detection point is located in a reverse direction with respect to the previous detection point, the controller 14 determines that the operation detected is not a continuous operation. For the controller 14 of the present embodiment, a detection point two periods earlier, for example, is used as the previous detection point.

Specifically, the controller 14 determines whether the operation detected is a continuous operation for the component of the first coordinate axis (X component) at the detection point 105, and separately, for the component of the second coordinate axis (Y component) at the detection point 105. For example, as illustrated in FIG. 2B, when at least one of the shift direction of the X component and the shift direction of the Y component is reversed, the controller 14 makes a determination as to operation continuity.

For example, in the case that the detection point 105 shifts from coordinates (X₁, Y₁), to coordinates (X₂, Y₂), and to coordinates (X₃, Y₃) as illustrated in FIG. 2B, the X component continues to shift in one direction, whereas the Y component changes from a shift in one direction to a shift in a reverse direction, and thus there is a reversal of the shift direction. Accordingly, the controller 14 makes a determination as to operation continuity for the Y component by using Y₃ as the reverse detection point and Y₁ as the previous detection point.

Here, the trajectory of the detection point 105 illustrated in FIG. 2B may not be a random one but may be a possible trajectory of an operation. Thus, the controller 14, for example, refrains from making a determination that there is no continuity by using one time determination of an absence of continuity, and instead, the controller 14 makes a determination that operation continuity is absent in the case that determinations of an absence of continuity are made a predetermined number of times or greater.

Accordingly, the controller 14 stores, in the memory 12, the number of determinations as count information 121. Based on the count information 121, the controller 14 checks the number of determinations. A modified example of the operation detection device 1 may be configured to include a count information generation unit that generates the count information 121.

In the following, determination as to the continuity will be described more specifically with reference to FIGS. 3A to 3C.

For example, as illustrated in FIG. 3A, in the case that the shift from a detection point Xₐ, to a detection point X_{b}, and to a detection point X_{c} is in one direction (direction indicated by an arrow A) in this order and the shift to the detection point X_{d} is in a reverse direction (direction indicated by an arrow B), the controller 14 designates the detection point X_{d}, which is in the shift direction reversed from the X-axis positive direction (direction indicated by the arrow A) to the X-axis negative direction (direction indicated by the arrow B), as the reverse detection point.

The controller 14 makes a determination as to operation continuity by using the detection point X_{b} as a previous detection point X_{b}. The detection point X_{b} is a detection point two periods earlier than the reverse detection point X_{d}, which is in the reversed shift direction. The shift direction of the detection point before the reversal is a shift in the direction of the X-axis positive direction (direction indicated by the arrow A) and the location of the reverse detection point X_{d} is in the positive direction (direction indicated by the arrow A) with respect to the previous detection point X_{b}, that is, the reverse detection point X_{d} is greater than the previous detection point X_{b}. Based on this, the controller 14 determines that the operation is continuous.

Further, for example, as illustrated in FIG. 3B, in the case that the shift from the detection point Xₐ, to the detection point X_{b}, and to the detection point X_{c} is in one direction (direction indicated by the arrow B) in this order and the shift to the detection point X_{d} is in a reverse direction (direction indicated by the arrow A), the controller 14 designates the detection point X_{d}, which is in the shift direction reversed from the X-axis negative direction (direction indicated by the arrow B) to the X-axis positive direction (direction indicated by the arrow A), as the reverse detection point.

The controller 14 makes a determination as to operation continuity by using the detection point X_{b} as a previous detection point X_{b}. The detection point X_{b} is a detection point two periods earlier than the reverse detection point X_{d}, which is in the reversed shift direction. The shift of the detection point before the reversal is in the shift direction of the X-axis negative direction (direction indicated by the arrow B) and the location of the reverse detection point X_{d} is in the positive direction (direction indicated by the arrow A) with respect to the previous detection point X_{b}, that is, the reverse detection point X_{d} is greater than the previous detection point X_{b}. Based on this, the controller 14 determines that the operation is not continuous.

Here, “reverse detection point X_{d} is greater than the previous detection point X_{b}” indicates that the length of movement of the operating finger 8 is excessively large. A possible reason for this may be, for example, randomness of the coordinates of the detection point 105 due to erroneous detection of the electrostatic capacitance to be read, which may be caused by a temperature decrease resulting from, for example, contact of the operating surface 100 with cold air from the air conditioning device.

In the case that the reverse detection point X_{d} is located between the detection point X_{c} and the previous detection point X_{b}, the reverse detection point X_{d} is located in the negative direction with respect to the previous detection point X_{b}, that is, the reverse detection point X_{d} is smaller than the previous detection point X_{b}. Based on this, the controller 14 determines that the operation is continuous.

Further, for example, as illustrated in FIG. 3C, in the case that the shift from the detection point Xₐ, to the detection point X_{b}, and to the detection point X_{c} is in the positive direction (direction indicated by the arrow A) in this order and the shift to the detection point X_{d} is in a reverse direction (direction indicated by the arrow B), the controller 14 designates the detection point X_{d}, which is in the shift direction reversed from the X-axis positive direction (direction indicated by the arrow A) to the X-axis negative direction (direction indicated by the arrow B), as the reverse detection point.

The controller 14 makes a determination as to operation continuity by using the detection point X_{b} as a previous detection point X_{b}. The detection point X_{b} is a detection point two periods earlier than the reverse detection point X_{d}, which is in the reversed shift direction. The shift of the detection point before the reversal is in the shift direction of the X-axis positive direction (direction indicated by the arrow A) and the location of the reverse detection point X_{d} is in the positive direction (direction indicated by the arrow A) with respect to the previous detection point X_{b}, that is, the reverse detection point X_{d} is greater than the previous detection point X_{b}. Based on this, the controller 14 determines that the operation is continuous.

Next, in the case that the shift from the detection point X_{c}, to the detection point X_{d}, and to a detection point Xₑ is in the negative direction (direction indicated by the arrow B) in this order and the shift to a detection point X_{f} is in the positive direction (direction indicated by the arrow A), the controller 14 designates the detection point X_{f}, which is in the shift direction reversed from the X-axis negative direction (direction indicated by the arrow B) to the X-axis positive direction (direction indicated by the arrow A), as the reverse detection point.

The controller 14 makes a determination as to operation continuity by using the detection point X_{d} as a previous detection point X_{d}. The detection point X_{d} is a detection point two periods earlier than the reverse detection point X_{f}, which is in the reversed shift direction. The shift of the detection point before the reversal is in the shift direction of the X-axis negative direction (direction indicated by the arrow B) and the location of the reverse detection point X_{f} is in the positive direction (direction indicated by the arrow A) with respect to the previous detection point X_{d}, that is, the reverse detection point X_{f} is greater than the previous detection point X_{d}. Based on this, the controller 14 determines that the operation is not continuous.

In the case that the controller 14 determines that operation continuity is absent for at least one of the X component and the Y component, the controller 14 designates the detection point having the X component and the Y component as a detection point lacking operation continuity.

Further, in the case that the controller 14 determines, a predetermined number of times or greater, that the operation detected is not a continuous operation, the controller generates the calibration signal S₂ for calibration of the touch pad 10 and outputs the calibration signal S₂ to the touch pad 10. The predetermined number of times is, for example, three, but other numbers are possible.

The controller 14 generates operation information S₃ based on the detection point information S₁ and the result of the determination and outputs the operation information S₃ to the connected electronic device. During the time period in which an operation having continuity, according to the result of the determination, takes place, the controller 14 outputs operation information S₃ in accordance with the coordinates of the detection point 105. Further, in the case that, according to the result of the determination, the controller 14 performs calibration, the controller 14, for example, outputs operation information S₃ indicating that calibration is to be performed.

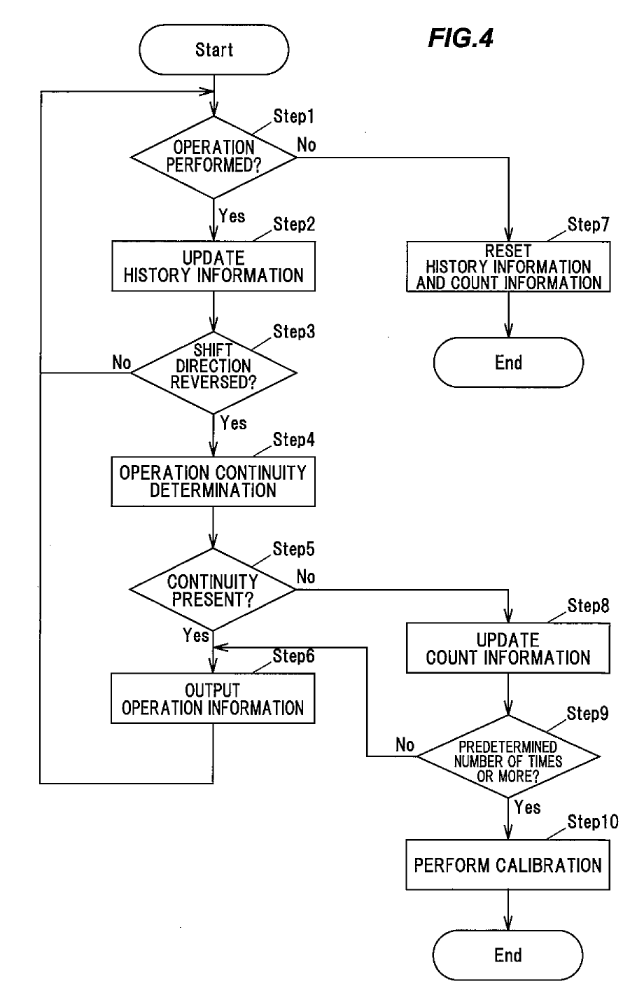

An example of the processing of the operation detection device 1 of the present embodiment will be described below with reference to the flowchart of FIG. 4.

### Processing

Upon powering of the vehicle 9, the controller 14 of the operation detection device 1 periodically acquires the detection point information S₁ from the touch pad 10. The controller 14 determines, based on the detection point information S₁, the presence or absence of an operation. In the case that an operation is detected based on the detection point information S₁ (Step 1: Yes), the controller 14 outputs the detection point information S₁ to the memory 12 to update the history information 120 (Step 2).

Based on the history information 120, the controller 14 checks whether there is a reversal of the shift direction, for the X component and for the Y component, independently of each other. Here, in the case that there are not, in the history information 120, a sufficient number of detection points 105 for making a determination as to a reversal of the shift direction, the controller 14 determines that there is no reversal and allows the process to proceed to step 1 to acquire detection point information S₁ for the next period (Step 3: No). In the case that there are three detection points 105 for making a determination as to a reversal and the controller 14 determines, based on the coordinates of the three detection points 105, that there is no reversal, either for the X component or for the Y component, the controller 14 allows the process to proceed to step 1.

In the case that the controller 14 determines, based on the current detection point 105 and two detection points 105 stored in the history information 120, that there is a reversal of the shift direction (Step 3: Yes), the controller 14 makes a determination as to the continuity of the operation detected (Step 4).

In the case that continuity is present (Step 5: Yes), the controller 14 generates operation information S₃ based on the acquired detection point 105, outputs the operation information S₃ to the electronic device (Step 6), acquires detection point information S₁ for the next period, and returns to step 1.

In step 1, in the case that no operation is detected (Step 1: No), the controller 14 resets the history information 120 and the count information 121 (step 7) to terminate the processing.

In step 5, in the case that the controller 14 determines that operation continuity is absent (Step 5: No), the controller 14 updates the count information 121 (Step 8). Further, in the case that, based on the count information 121, the number of times that the determination of an absence of continuity is made is a predetermined number of times or greater (Step 9: Yes), the controller 14 outputs the calibration signal S₂ and performs calibration of the touch pad 10 (Step 10).

In step 9, in the case that the number of times that the determination of an absence of continuity is made is less than the predetermined number of times (Step 9: No), the controller 14 outputs operation information S₃, acquires detection point information S₁ for the next period, and allows the process to proceed to step 1.

### Effects of Embodiment

The operation detection device 1 according to the present embodiment performs calibration upon the occurrence of an anomaly in detection of operations and thus has improved operability. Specifically, the operation detection device 1 determines, based on the history information 120, that operation continuity is absent, with the detection point 105 shifting randomly, which may be due to, for example, a decrease in the temperature of the operating surface 100 during operation by the operator. Thus, the operation detection device 1 can rapidly perform calibration. Consequently, the operation detection device 1 can perform calibration in a shortened time by, for example, several seconds compared with the case in which calibration is performed at a predetermined timing. As a result, the period of time from the occurrence of an anomaly in detection to the completion of calibration is shortened and thus the operability is improved.

The operation detection device 1 makes a determination as to operation continuity as follows. In the case that it is detected that the shift of the detection point 105 is in one direction and subsequently it is detected that the shift is in a reverse direction, the determination is made based on the direction of the shift of the detection point 105 before the reversal and the positions of the reverse detection point and the previous detection point. Thus, compared with the case in which a determination as to a detection anomaly is carried out by, for example, calculation of the distance between detection points, the load of the controller 14 is low, and as a result, use of a low-cost microcomputer is made possible. Thus, the operation detection device 1 is produced at low cost.

The operation detection device 1 according to the above-described embodiment and modifications may, depending on the application, be partially realized as a program executed by a computer, an application specific integrated circuit (ASIC), a field programmable gate array, or the like, for example.

Although several embodiments and modifications of the invention have been described above, these embodiments and modifications are merely examples, and the invention according to the claims is not intended to be limited to the embodiments and modifications. Such novel embodiments and modified examples can be implemented in various other forms, and various omissions, substitutions, changes, and the like can be made without departing from the spirit and scope of the invention. In addition, all combinations of the features described in these embodiments and modifications are not necessary means to solve the problem. Furthermore, these embodiments and modified examples are included within the spirit and scope of the invention and also within the scope of the invention described in the claims and equivalents thereof.

### REFERENCE SIGNS LIST

1 Operation detection device
8 Operating finger
10 Touch pad
12 Memory
14 Controller
100 Operating surface
105 Detection point
120 History information

1. An operation detection device, comprising:
an operation detection unit configured to periodically detect an operation performed on an operating surface by a detection target and to calculate a detection point on the operating surface, the detection point being a point where the detection target is detected;
a history information generation unit configured to store the detection point as a time series to generate a history information; and
a controller configured to perform a calibration of the operation detection unit if the controller determines, based on the history information of the operation detected by the operation detection unit, that the operation detected is not a continuous operation.

2. The operation detection device according to claim 1, wherein if, based on the history information, it is detected that a shift of the detection point is in one direction and subsequently it is detected that there is a reversal of the one direction of the shift, the controller is configured to compare a reverse detection point where the reversal is detected with a previous detection point which is detected a plurality of periods earlier than the reverse detection point, and, if the reverse detection point is located in a direction reverse to the one direction with respect to the previous detection point, to determine that the operation detected is not the continuous operation.

3. The operation detection device according to claim 2, wherein the operation detection unit defines on the operating surface a two-dimensional coordinate system comprising a first coordinate axis and a second coordinate axis intersecting the first coordinate axis, and
wherein the controller is configured to determine whether the operation detected is the continuous operation with respect to each of a component of the first coordinate axis at the detection point and a component of the second coordinate axis at the detection point.

4. The operation detection device according to claim 1, wherein the controller is configured to perform the calibration of the operation detection unit if the controller determines, not less than a predetermined number of times, that the operation detected is not the continuous operation.

5. The operation detection device according to claim 3, wherein if it is determined at one detection point that an operation continuity is absent with respect to at least one of the component of the first coordinate axis and the component of the second coordinate axis, the controller is configured to determine that the operation continuity is absent at the one detection point.

6. The operation detection device according to claim 2, wherein occurrence of the reversal of the direction of the shift of the detection point is determined based on coordinates of the reverse detection point and coordinates of the previous detection point detected two or more periods earlier than the reverse detection point.
